(19) United States
(12) Patent Application Publication
(10) Pub. No.: US 2007/0170610 A1
(43) Pub. Date: Jul. 26, 2007

(54) METHOD FOR THE PRODUCTION OF PATTERNED DESIGNS

(75) Inventors: Justin Payne, Blackburn (GB); David Ponton, Blackburn (GB); Alister Rigby, Bolton (GB)

Correspondence Address: GREENBLUM & BERNSTEIN, P.L.C., 1950 ROLAND CLARKE PLACE, RESTON, VA, 20191, US

(73) Assignee: VOITH PAPER PATENT GMBH, Heidenheim (DE)

(21) Appl. No.: 11/276,110

(22) Filed: Feb. 14, 2006

(30) Foreign Application Priority Data
Feb. 15, 2005 (DE) 10 2005 006 737.9

(51) Int. Cl. B32B 5/26; B29C 67/00

(52) U.S. Cl. 264/13; 442/248; 425/375; 264/555

(57) ABSTRACT

A method for the production of a fabric for industrial use comprising extruding polymer material onto a carrier structure to produce a patterned design on the carrier structure, wherein a cross-sectional profile of the extruded polymer material is substantially convex. An apparatus for carrying out the method comprising a polymer extrusion apparatus structured and arranged to move in three mutually perpendicular directions. A fabric comprising a carrier structure and a patterned design comprising extruded polymer material arranged on the carrier structure, wherein the extruded polymer material is arranged to form a substantially convex cross section on the carrier structure. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of German Patent Application No. 10 2005 006 737.9 filed Feb. 15, 2005, the disclosure of which is expressly incorporated by reference herein in its entirety.

### BACKGROUND OF THE INVENTION

1. Field of the Invention

The invention relates to a method for the production of patterned designs and to an apparatus for carrying out the method. It further relates to a fabric for industrial use, in particular a papermachine fabric.

2. Discussion of Background Information

Screen printing for use on paper machine fabrics is known. For example, U.S. Pat. No. 5,115,544 discloses a method for the production of a non-woven fabric which has specifically configured patterns in designated regions formed by printing or stitching techniques. While a continuous or a non-continuous pattern can be achieved by the stitching method, the pattern is subject to early distortion and even failure in use, which makes it appear impractical for production.

In relation to screen printing techniques, various designs can be achieved with restrictions, for example up to at most 70,000 cP (as measured by the Brookfield viscometer using the ASTM D2196-99 test method), with standard screen production (specifically the Saxon Screens method). A disadvantage of such screen printing techniques is that the maximum thickness is 0.3 mm. Furthermore, what is known as the ice cream effect occurs, the viscoelasticity of the material itself causing air bubble inclusions and an uneven and inconsistent surface quality. An additional disadvantage is that the minimum thickness is 0.05 mm (as documented by Saxon Screens data). An even further disadvantage is that restrictions in the screen production process (nickel electroplating method) dictate what line width can be achieved.

If laser or water jet cutting technologies are used on a blank screen, it is possible to achieve limited bridge widths and restricted line widths. However, a truly continuous line can never be achieved, since this would cause screen defects and this process results in a poorer surface quality as compared with the nickel plating method.

International Publication No. WO 00/75423 A1 teaches the production of a lattice by using die extrusion. This method does not permit the generation of 360° oriented, complex, non-continuous designs, but rather only machine-direction oriented designs. A further restriction is that it teaches the extrusion of material “onto” the surface of the substrate and is therefore restricted in terms of application and adhesive effect.

The known patterned designs on industrial fabrics have a surface structure which is often unsatisfactory, since this does not make it possible to produce clear and attractive decorative patterns, for example on a paper web or tissue web.

### SUMMARY OF THE INVENTION

The invention provides a method for the production of patterned designs, a suitable apparatus for carrying out the method, and a corresponding fabric. More particularly, the invention relates to a high-quality patterned design to be produced on a carrier structure using simple process technology, which can be produced in any desired direction, either continuously or non-continuously and which is suitable for generating clear and attractive patterns, for example, on paper webs.

Further, the invention relates to a method for the production of an industrial fabric having a patterned design on a carrier structure. The patterned design is produced by extrusion of polymer material onto the carrier structure, and the extrusion process is guided in such a way that the cross-sectional profile of the extruded polymer material is substantially convex.

The invention also relates to an apparatus for carrying out the method. The apparatus includes a polymer extrusion apparatus which can be moved in three mutually perpendicular directions. Alternatively, it can also include at least one laser head.

According to the invention, a fabric includes a patterned design produced by extrusion of polymer material, in which the extruded polymer material forms a substantially convex cross section on the carrier structure.

According to the invention, therefore, a patterned design extruded from polymer material is created on a carrier structure, and the patterned design including continuous or non-continuous polymer lines or polymer beads.

The carrier structure can be an integral constituent part of the fabric. Alternatively, the carrier structure can be a substrate from which the patterned design produced is detached in order to form an “isolated” structure, which is subsequently joined to the fabric. In the latter, the carrier structure can be a coated belt, which makes detachment easier.

The patterned design can be produced, at least in some sections, by a continuous line with the same cross section and/or varying cross section. The varying cross section is preferably produced by polymer beads lined up in a row with one another.

In order to form the patterned design, use is preferably made of a three-dimensional polymer extrusion apparatus having at least one spraying head with at least one extrusion tube therein.

Designs can be created, for example, in AUTOCAD or in other drawing software, which can then be transferred directly or indirectly to the XYZ movement control system that controls the movement of the measuring head.

The invention is more highly repeatable than similar products which can be achieved according to the prior art.

The invention is characterized by its geometric shape and consistency. The invention provides a usable polymer viscosity of greater than 70,000 cP, and preferably 100,000 cP to 150,000 cP.

The invention also provides a pattern height of 0.001 mm to 5.0 mm above the carrier structure (the prior art minimum value is 0.05 and maximum value is 1.0).

The invention additionally provides a width to height ratio of up to 1:1 (the prior art provides 1:0.7 for silicone and 1:0.5 for polyurethane).

The invention further provides a detachment tendency of the polymer pattern structure which is improved as compared with the prior art.

The invention also provides imprint quality in the final medium (e.g., paper, non-woven) as measured, e.g., by CT scanner.

The invention additionally provides an unrestricted bridge width, whereas the prior art demands a minimum bridge width of 0.7:1 of the screen thickness.

The polymer can comprise polyurethane, silicone, polyureas, low molecular weight oligomers or any combination thereof.

The needle geometry can be configured so as to extrude the desired profiles, e.g., round, rectangular, polygonal, etc.

According to the invention, a laser head can be fitted instead of an extrusion head.

A further aspect of the invention is to implement a continuously variable and adaptable polymer penetration depth in the body of the carrier structure, which uses the combination of the polymer tack and the z-direction head control. Consequently, a 3-D watermark effect could be applied to a forming fabric in order to control the distribution of the solids content within the paper sheet.

A further aspect of the invention is that, at the start and at the end of each pattern or pattern element, the tube is moved gradually away from the carrier structureltoward the substrate, in order to overcome the problems with the prior art of “tailing”.

In an exemplary embodiment, a reinforced patterned design is produced with a filament or yarn is introduced at the same time and held firmly by the polymer.

In another exemplary embodiment, two or more polymers are simultaneously fed through a feed tube in order to produce a multifunctional patterned design for increased elasticity.

According to the invention, there is a polymer 3D patterned design. The polymer 3D patterned design may be a uniform application to a forming fabric or TAD fabric for use as a decorative pattern. The design may be a z-direction profile which is deliberately undulating, for example to produce tissue with a reinforced surface effect.

The invention is applicable to a forming fabric in order to effect a watermark effect by redistribution of the solids content of the sheet.

Further, the invention is applicable to or in a press felt, in order to produce a pattern during the pressing of the sheet which causes a bodily impression in the sheet.

The invention is also applicable to or in a dryer fabric, in order to produce a pattern during the drying phase of the sheet which causes a bodily impression in the sheet.

The invention is applicable to a specific region or specific regions of a forming fabric or TAD fabric (for example, for sealing the edges and/or the in-register introduction of a company logo by watermarks or by bodily impression in the sheet).

According to the invention there is an application of machine direction lines of polymer of various height over the width of the basic structure (e.g., woven fabric, spiralized basic structure, laid filament structure). This is used to adjust the compression loading profile of the press felt which results, as measured under the dynamic conditions of the press, to balance out the incorporated press load changes over the machine width.

According to the invention there is an application for the use of each of the above production techniques in fabrics which are assigned to the non-woven machine, where they are used for air-layering or spun non-woven production.

According to the invention, there is a method for producing an industrial use fabric comprising extruding polymer material onto a carrier structure to produce a patterned design on the carrier structure, wherein a cross-sectional profile of the extruded polymer material is substantially convex. The patterned design may be a three-dimensional patterned design, The patterned design may be continuous in some regions, and may be non-continuous in some regions.

The patterned design may be an isolated structure and the carrier structure may comprise a belt coated for subsequent detachment of the patterned design.

The patterned design may comprise a continuous line of substantially constant cross section. The patterned design may comprise a continuous line with varying cross section, wherein the line is formed by lining up polymer beads in a row with one another to produce the varying cross section. The polymer beads may be produced using a polymer extrusion apparatus movable in three mutually perpendicular directions. The polymer extrusion apparatus is drivable to produce three-dimensional patterned designs. The polymer extrusion apparatus may comprise at least one of a spraying head and an extrusion head. The polymer extrusion apparatus may comprise at least one extrusion tube.

According to the invention, a viscosity of the polymer material is greater than 70,000 cP, preferably in a range from about 100,000 cP to about 150,000 cP.

The height of the patterned design may lie in a range from about 0.001 mm to about 5 mm. Furthermore, a height of the patterned design above the carrier structure may lie in a range from about 0.001 mm to about 5 mm. A ratio of a width of the patterned design to a height of the patterned design may lie in a range up to 1:1.

The polymer material comprises at least one of: silicone, polyureas, and low molecular weight oligomers. The patterned design may be produced with at least one laser head.

The method further comprises varying a penetration depth of the polymer material, wherein the penetration depth is varied by at least one of: varying a polymer tack and driving a spraying head or extrusion head in a vertical (z) direction.

The extruding may comprise introducing a filament or yarn into the polymer material. The extruding may comprise extruding two or more polymer materials simultaneously through an extrusion or feed tube.

The invention may further comprise applying the polymer material to a forming fabric or to a TAD fabric to produce a decorative patterned design. The patterned design is applied to at least one of seal edges and in-register introduce a company logo by one of watermarks or bodily impression in a sheet. The patterned design may comprise an undulating z-direction profile.

The invention further comprises applying the patterned design to a forming fabric, whereby a watermark effect is producible in a sheet through redistribution of solids content of the sheet. The invention further comprises applying or introducing the patterned design to or into a press felt, whereby a pattern is producible by pressing a sheet to cause a bodily impression in the sheet. The invention further comprises applying or introducing the patterned design to or into a dryer fabric, whereby a pattern is producible during a drying phase of a sheet through a bodily impression in the sheet.

The invention comprises applying the patterned design to at least one region of a belt or the fabric. The invention comprises applying machine direction lines of the polymer material of various height over a width of the fabric. The invention comprises applying the patterned design to a fabric assigned to a non-woven machine for air-layering or spun non-woven production.

According to the invention, there is an apparatus for carrying out the method. The apparatus comprises a polymer extrusion apparatus structured and arranged to move in three mutually perpendicular directions. The polymer extrusion apparatus is drivable to produce three-dimensional patterned designs. The polymer extrusion apparatus may comprise at least one of a spraying head and an extrusion head. The polymer extrusion apparatus may comprise at least one extrusion tube. The polymer extrusion apparatus may be structured and arranged to supply two or more polymers simultaneously via the extrusion tube. The polymer extrusion apparatus may be structured and arranged to introduce a filament or yarn into the polymer material during the extruding. The polymer extrusion apparatus may comprise at least one laser head.

According to the invention, there is a fabric comprising a carrier structure and a patterned design comprising extruded polymer material arranged on the carrier structure, wherein the extruded polymer material is arranged to form a substantially convex cross section on the carrier structure. The patterned design may be three-dimensional. The patterned design may comprise continuous regions. The patterned design may comprise non-continuous regions. The patterned design may be produced as an isolated structure. The patterned design may comprise a continuous line of substantially constant cross section. The patterned design may comprise a continuous line having a varying cross section, where the continuous comprises polymer beads arranged in row, and the polymer beads are structured and arranged to form the varying cross section. A viscosity of the extruded polymer material may be greater than 70,000 cP, preferably in a range from about 100,000 cP to about 150,000 cP. A height of the patterned design lies in a range from about 0.001 mm to about 5 mm, A height of the patterned design above the carrier structure lies in a range from about 0.001 mm to about 5 mm. A ratio between a width of the patterned design to a height of the patterned design lies in a range up to 1:1. The extruded polymer material comprises at least one of: silicone, polyureas, and low molecular weight oligomers. The patterned design may be produced, at least in some regions, by lasering. The patterned design may comprise a filament or yarn arranged in the extruded polymer material. The patterned design may comprise two or more extruded polymer materials that were simultaneous supplied. The patterned design may comprise an undulating z-direction profile.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a three-dimensional polymer extrusion apparatus;

FIGS. 2A and 2B show a comparison between extrusion profiles;

FIG. 3 shows an illustration of the trailing of the polymer during the screen application;

FIG. 4 shows a schematic illustration of a yarn/polymer tube application; and

FIG. 5 shows a schematic illustration of a polymer/polymer tube application.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

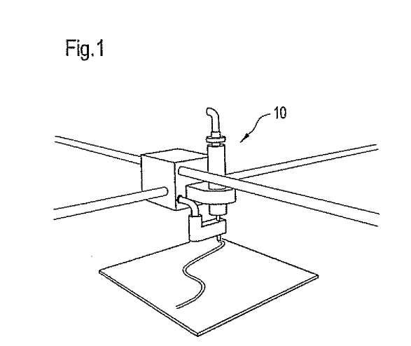

FIG. 1 shows a three-dimensional polymer extrusion apparatus 10. With this polymer extrusion apparatus 10, patterned designs having continuous or interrupted lines are produced. Further, three-dimensional polymer extrusion apparatus 10 is composed of at least one spraying head with at least one extrusion tube therein.

The pattern can be created, for example, in AUTOCAD or other drawing software, which is then transferred directly or indirectly to the XYZ movement control system which controls the movement of the measuring head.

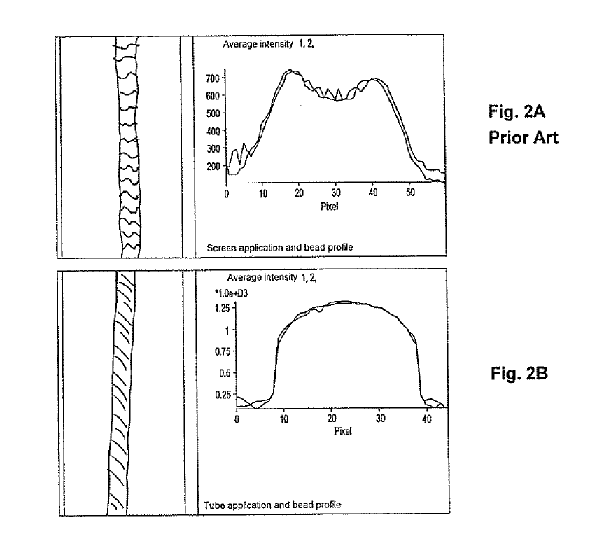

FIGS. 2A and 2B show a comparison between extrusion profiles and, in particular, the cross section of a polymer material extruded in accordance with the invention (FIG. 2B) as compared with the prior art (FIG. 2A) (measured by way of a laser profile scanning system such as the SCANTRON PRO SCAN).

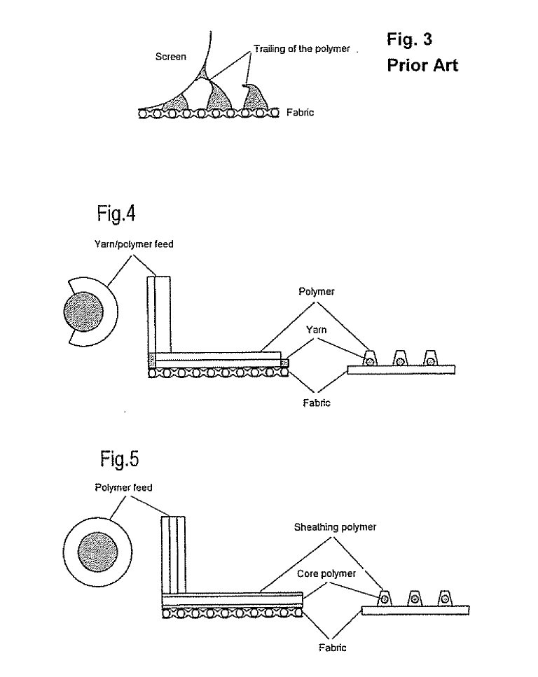

FIG. 3 shows the “trailing” of the polymer during prior art screen application. The invention avoids trailing by gradually moving the tube away from or toward the substrate at the start and at the end of each pattern or pattern element.

FIG. 4 shows a schematic illustration of a yarn/polymer tube application. In this case, a reinforced patterned design is produced by a filament or yarn being introduced at the same time and held firmly by the polymer.

FIG. 5 shows a schematic illustration of a polymer/polymer tube application. In this case, two or more polymers are led simultaneously through a feed tube in order to produce a multifunctional patterned design for increased elasticity.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for producing an industrial use fabric, comprising:
extruding polymer material onto a carrier structure to produce a patterned design on the carrier structure,
wherein a cross-sectional profile of the extruded polymer material is substantially convex.

2. The method as claimed in claim 1, wherein the patterned design is a three-dimensional patterned design.

3. The method as claimed in claim 1, wherein the patterned design is continuous in some regions.

4. The method as claimed in claim 1, wherein the patterned design is non-continuous in some regions.

5. The method as claimed in claim 1, wherein the patterned design is an isolated structure.

6. The method as claimed in claim 5, wherein the carrier structure comprises a belt coated for subsequent detachment of the patterned design.

7. The method as claimed in claim 1, wherein the patterned design comprises a continuous line of substantially constant cross section.

8. The method as claimed in claim 1, wherein the patterned design comprises a continuous line with varying cross section.

9. The method as claimed in claim 8, wherein the continuous line with varying cross section is formed by lining up polymer beads in a row with one another.

10. The method as claimed in claim 9, wherein the polymer beads are produced using a polymer extrusion apparatus movable in three mutually perpendicular directions.

11. The method as claimed in claim 10, wherein the polymer extrusion apparatus is drivable to produce three-dimensional patterned designs.

12. The method as claimed in claim 10, wherein the polymer extrusion apparatus comprises at least one of a spraying head and an extrusion head.

13. The method as claimed in claim 10, wherein the polymer extrusion apparatus comprises at least one extrusion tube.

14. The method as claimed in claim 1, wherein a viscosity of the polymer material is greater than 70,000 cP.

15. The method as claimed in claim 14, wherein the viscosity of the polymer material lies in a range from about 100,000 cP to about 150,000 cP.

16. The method as claimed in claim 1, wherein a height of the patterned design lies in a range from about 0.001 mm to about 5 mm.

17. The method as claimed in claim 1, wherein a height of the patterned design above the carrier structure lies in a range from about 0.001 mm to about 5 mm.

18. The method as claimed in claim 1, wherein a ratio of a width of the patterned design to a height of the patterned design lies in a range up to 1:1.

19. The method as claimed in claim 1, wherein the polymer material comprises at least one of; silicone, polyureas, and low molecular weight oligomers.

20. The method as claimed in claim 1 further comprising producing the patterned design with at least one laser head.

21. The method as claimed in claim 1, further comprising varying a penetration depth of the polymer material.

22. The method as claimed in claim 21, wherein the penetration depth is varied by at least one of: varying a polymer tack and driving a spraying head or extrusion head in a vertical (z) direction.

23. The method as claimed in claim 1, wherein the extruding comprises introducing a filament or yarn into the polymer material.

24. The method as claimed in claim 1, wherein the extruding comprises extruding two or more polymer materials simultaneously through an extrusion or feed tube.

25. The method as claimed in claim 1, further comprising applying the polymer material to a forming fabric or to a TAD fabric to produce a decorative patterned design.

26. The method as claimed in claim 1, wherein the patterned design comprises an undulating z-direction profile.

27. The method as claimed in claim 1, further comprising applying the patterned design to a forming fabric, whereby a watermark effect is producible in a sheet through redistribution of solids content of the sheet.

28. The method as claimed in claim 1, further comprising applying or introducing the patterned design to or into a press felt, whereby a pattern is producible by pressing a sheet to cause a bodily impression in the sheet.

29. The method as claimed in claim 1, further comprising applying or introducing the patterned design to or into a dryer fabric, whereby a pattern is producible during a drying phase of a sheet through a bodily impression in the sheet.

30. The method as claimed in claim 1, further comprising applying the patterned design to at least one region of a belt or the fabric.

31. The method as claimed in claim 1, further comprising applying machine direction lines of the polymer material of various height over a width of the fabric.

32. The method as claimed in claim 1, further comprising applying the patterned design to a fabric assigned to a non-woven machine for air-layering or spun non-woven production.

33. An apparatus for carrying out the method as claimed in claim 1, comprising:
a polymer extrusion apparatus structured and arranged to move in three mutually perpendicular directions.

34. The apparatus as claimed in claim 33, wherein the polymer extrusion apparatus is drivable to produce three-dimensional patterned designs.

35. The apparatus as claimed in claim 33, wherein the polymer extrusion apparatus comprises at least one of a spraying head and an extrusion head.

36. The apparatus as claimed in claim 33, wherein the polymer extrusion apparatus comprises at least one extrusion tube.

37. The apparatus as claimed in claim 36, wherein the polymer extrusion apparatus is structured and arranged to supply two or more polymers simultaneously via the extrusion tube.

38. The apparatus as claimed in claim 33, wherein the polymer extrusion apparatus is structured and arranged to introduce a filament or yarn into the polymer material during the extruding.

39. The apparatus as claimed in claim 33, wherein the polymer extrusion apparatus comprises at least one laser head.

40. A fabric, comprising:
a carrier structure,
a patterned design comprising extruded polymer material arranged on the carrier structure;
wherein the extruded polymer material is arranged to form a substantially convex cross section on the carrier structure.

41. The fabric as claimed in claim 40, wherein the patterned design is three-dimensional.

42. The fabric as claimed in claim 40, wherein the patterned design comprises continuous regions.

43. The fabric as claimed in claim 40, wherein the patterned design comprises non-continuous regions.

44. The fabric as claimed in claim 40, wherein the patterned design is produced as an isolated structure.

45. The fabric as claimed in claim 40, wherein the patterned design comprises a continuous line of substantially constant cross section.

46. The fabric as claimed in claim 40, wherein the patterned design comprises a continuous line having a varying cross section.

47. The fabric as claimed in claim 46, wherein the continuous line comprises polymer beads arranged in row, and the polymer beads are structured and arranged to form the varying cross section.

48. The fabric as claimed in claim 40, wherein a viscosity of the extruded polymer material is greater than 70,000 cP.

49. The fabric as claimed in claim 47, wherein the viscosity lies in a range from about 100,000 cP to about 150,000 cP.

50. The fabric as claimed in claim 40, wherein a height of the patterned design lies in a range from about 0.001 mm to about 5 mm.

51. The fabric as claimed in claim 40, wherein a height of the patterned design above the carrier structure lies in a range from about 0.001 mm to about 5 mm.

52. The fabric as claimed in claim 40, wherein a ratio between a width of the patterned design to a height of the patterned design lies in a range up to 1:1.

53. The fabric as claimed in claim 40, wherein the extruded polymer material comprises at least one of: silicone, polyureas, and low molecular weight oligomers.

54. The fabric as claimed in claim 40, wherein the patterned design is produced, at least in some regions, by lasering.

55. The fabric as claimed in claim 40, wherein the patterned design comprises a filament or yarn arranged in the extruded polymer material.

56. The fabric as claimed in claim 40, wherein the patterned design comprises two or more extruded polymer materials that were simultaneous supplied.

57. The fabric as claimed in claim 40, wherein the patterned design comprises an undulating z-direction profile.

58. The method as claimed in claim 1, wherein the fabric comprises a papermachine fabric.

59. The method as claimed in claim 30, wherein the belt or fabric comprises a forming fabric or TAD fabric.

60. The method as claimed in claim 59, wherein the patterned design is applied to at least one of seal edges and in-register introduce a company logo by one of watermarks or bodily impression in a sheet.

61. The fabric as claimed in claim 40, wherein the fabric comprises a papermachine fabric.
